(19) United States
(12) Patent Application Publication
(10) Pub. No.: US 2004/0239290 A1
(43) Pub. Date: Dec. 2, 2004

(54) Combination jump starter and high frequency charger

(75) Inventor: Michael Krieger, Miami Beach, FL (US)

Correspondence Address: VENABLE, BAETJER, HOWARD AND CIVILETTI, LLP, P.O. BOX 34385, WASHINGTON, DC, 20043-9998, US

(73) Assignee: Vector Product, Inc., Ft. Lauderdale, FL

(21) Appl. No.: 10/805,384

(22) Filed: Mar. 22, 2004

Related U.S. Application Data
(60) Provisional application No. 60/456,183, filed on Mar. 21, 2003.

(51) Int. Cl. H02J 7/14

(52) U.S. Cl. 320/105

(57) ABSTRACT

A portable jump starter/charger combination includes a housing and a jump starter battery enclosed within the housing for providing a first DC output. A battery charger is also enclosed within the housing and provides a second DC output. A function selector switch has a first input coupled to the first DC output of the jump starter battery, a second input coupled to the second DC output of the charger and an output coupled to battery cables. The function selector switch is operative to selectively connect one of the first and second inputs to the output of the function selector for either jump starting a vehicle with a dead battery or charging the dead battery through the pair of battery cables.

### BACKGROUND OF THE INVENTION

1. Field of the Invention

The present invention relates to a portable, vehicle jump starter/battery charger.

2. Related Art

There are a number of portable jump starters for vehicles having a dead starter battery. Such units provide the ability to jump-start a motor when another vehicle's battery is not available to the motorist. Portable jump starters usually have an internal battery which is used to jump start the vehicle.

Additionally, there exist charging devices that can recharge a drained battery. These devices either convert AC power to DC power to charge the battery or contain a battery which is then used to charge the drained battery. It is also known from U.S. Pat. No. 5,793,185 to combine a charging device with a jump starter to provide the motorist with several options. However, this patent teaches jumpstarting the vehicle through a set of jumper cables, and charging the dead vehicle battery from a DC output that presumably requires a separate set of cables connected between the DC output and the terminals of the dead battery. This is cumbersome because the separate set of connecting cables can be become separated from the jump starter/charger and therefore may not be readily available when the need to charge arises.

Further, the known devices do not take advantage of their internal battery in addressing other possible needs of a motorist.

Therefore, there is a need for a portable jump starter/charging device that is easy to use and that also supplies additional functionality.

### SUMMARY OF THE INVENTION

In an exemplary embodiment, a portable jump starter/charger apparatus is provided that comprises: a housing; an internal battery, housed inside the housing; a pair of jumper cables coupled to the internal battery; and a function selector switch operative to switch between jump starting an external battery with the pair of jumper cables, and charging an external battery with the pair of jumper cables.

Further features and advantages of the invention, as well as the structure and operation of various embodiments of the invention, are described in detail below with reference to the accompanying drawings.

### BRIEF DESCRIPTION OF THE DRAWINGS

FIG. 1 illustrates a front side view of a jump starter/charger according to an exemplary embodiment of the invention;

FIG. 2 illustrates a rear side view of a jump starter/charger according to an exemplary embodiment of the invention; and

FIG. 3 is block circuit diagram illustrating the an exemplary embodiment of the invention.

### DETAILED DESCRIPTION OF THE INVENTION

An embodiment of the invention is discussed in detail below wherein like reference numbers generally indicate identical, functionally similar, and/or structurally similar elements. While specific exemplary embodiments are discussed, it should be understood that this is done for illustration purposes only. A person skilled in the relevant art will recognize that other components and configurations can be used without departing from the spirit and scope of the invention.

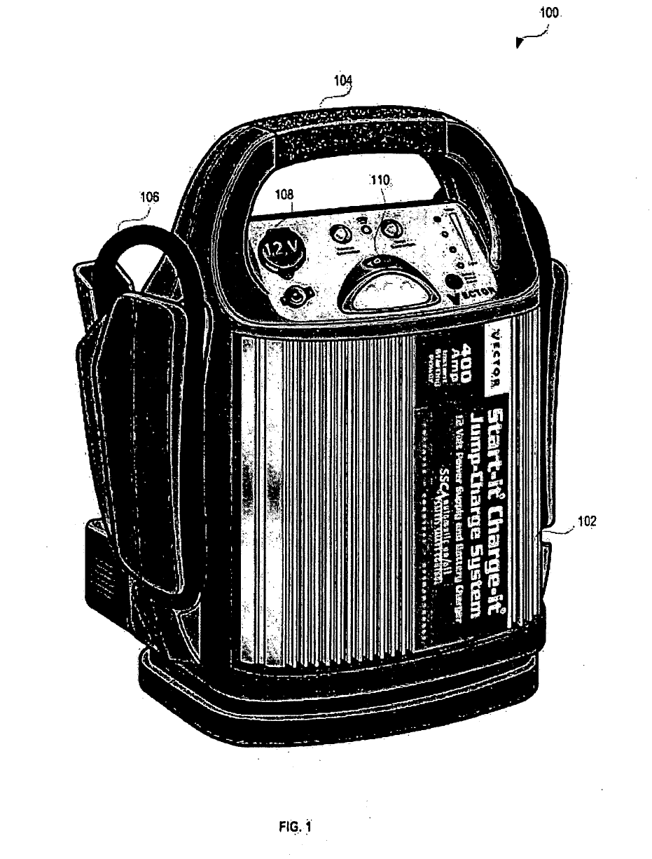

FIG. 1 illustrates a front side view of a jump starter/charger 100 according to an exemplary embodiment of the invention. The jump starter/charger has an external housing 102 with a handle 104. A jump starting circuit including a battery for a jump starting operation is provided in the housing. A charging circuit for a charging operation is also provided in the housing. The jump starter/charger also has two conventional jumper cables, including a positive jumper cable 106 and a negative jumper cable (not visible) in FIG. 1. The positive and negative cables are selectively coupled to the jump starting circuit and the charging circuit. A function selector switch 110 may be provided for selecting either a jump starting mode or a charging mode of the jump starter/charger, as is discussed in more detail below. The function selector switch may be a manually operated or automatically operated. The jump starter/charger 100 may further include a 12 volt DC output socket 108. DC output socket 108 may be configured to receive a cigarette plug adapter.

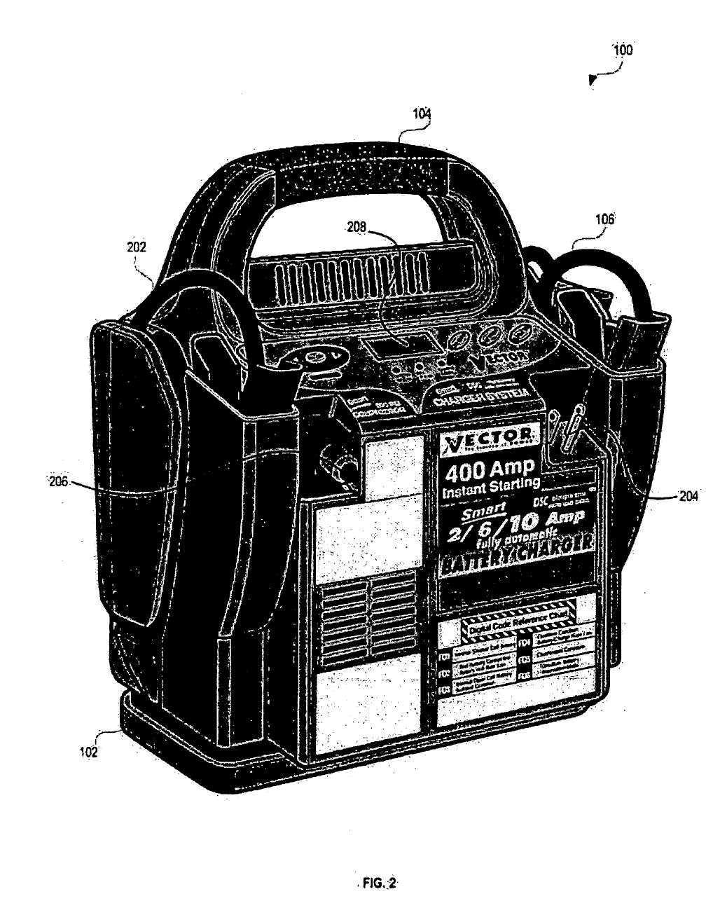

FIG. 2 illustrates a rear side view of a jump starter/charger 100 according to an exemplary embodiment of the invention. The negative jumper cable 202 is stored on an opposite side from the positive jumper cable 106. The jump starter/charger 100 also has an AC input plug 204 adapted for connection to an external AC source for supplying power to the jump starter/charger. In addition, an air compressor 206, which can be used for inflating tires, for example, may be contained within the same housing. The housing may also includes a display 208 that can indicate the state of the apparatus and of the jumpstarting and charging operation, including error codes generated by diagnostics as discussed below.

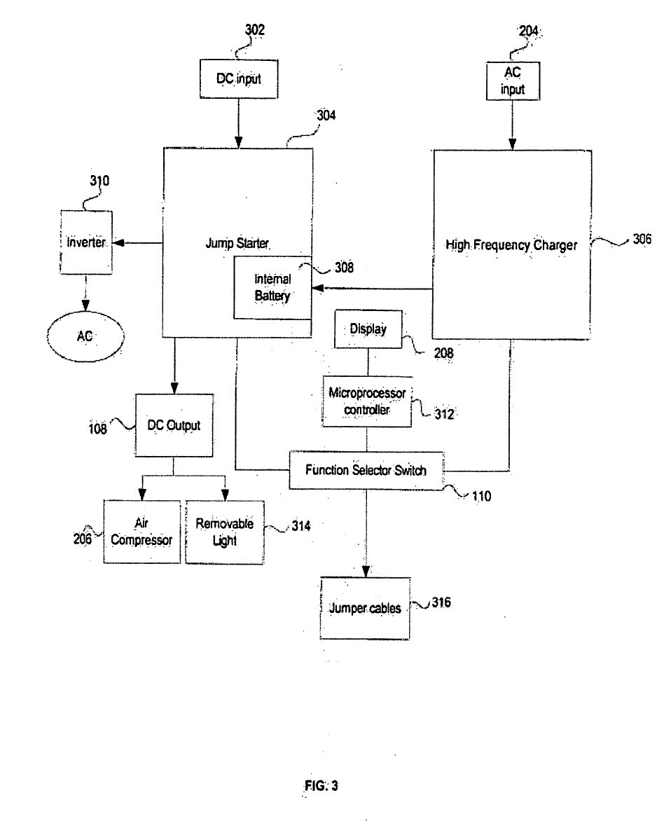

FIG. 3 is a block circuit diagram of an exemplary embodiment of the system of the present invention. The AC input 204 may be coupled to the charging circuit, which may be a high frequency charger 306. An example of a high-frequency charger that may be used to implement the present invention is described in U.S. patent application Ser. No. 10/270,391, entitled “A High Frequency Battery Charger and Method of Operating Same,” commonly owned by the Assignee of the present application and the disclosure of which is incorporated herein by reference in its entirety.

In addition to the AC input plug 204, the apparatus may also have a DC input 302. The DC input 302 is coupled to the jump starter circuit 304, and can charge the internal battery 308 of the jump starter circuit 304 directly. The internal battery 308 can also be charged by the high frequency charger 306. A microprocessor, described below, may be used to control the charging process.

An example of a jump starter that may be used to implement the present invention is described in U.S. patent application Ser. No. 10/315,061 entitled “Microprocessor Controlled Jump Starter System With Polarity Protection,” commonly owned by the Assignee of the present application and the disclosure of which is incorporated herein by reference in its entirety. The jump starter circuit of the present invention may include a polarity protection circuit (not shown) that can be electrically coupled to the depleted battery and to the internal battery 308. The polarity protection circuit can prevent current flow between the batteries unless a proper polarity connection is achieved, i.e. the positive terminal of the internal battery is connected to the positive terminal of the depleted battery and the negative terminal of the internal battery is connected to the negative terminal of the depleted battery. The above-mentioned U.S. patent application Ser. No. 10/315,061 describes a polarity protection circuit that may be used to implement this aspect of the described embodiment.

Both the jump starter 304 and the high frequency charger 306 have their own internal diagnostics (not shown, but described and illustrated in the above mentioned applications incorporated herein by reference) that check, for example, the status of the internal and/or depleted battery and whether the jumper cables are correctly attached to the external battery. The diagnostics can generate error codes which the microprocessor 312 can display on display 208 to notify the user of an error.

Both the jump starter 304 and the high frequency charger 306 may be coupled to the function selector switch 110. The function selector switch 110 may be either a manually operated or an automatoically operated. The function selector switch 110 that is automatically operated may be controlled by the microprocessor controller 312 or other suitable controller. The function selector switch 110 may be used to selectively connect the jumper cables to the output of the jump starter 304 and the output of the high frequency charger 306. Thus, both the jump starter 304 and the high frequency charger 306 use the same set of jumper cables 316.

In another embodiment of the invention, the jump starter/charger 100 may automatically determine whether to operate the jump starter 304 or the high frequency charger 306. For example, the high frequency charger 306 may be configured to operate only when there is AC power supplied to the charger via AC input 204. If no AC power is input to the charger, the jump starter 304 is operated. The function selector switch 110 is then operated accordingly. Alternately, the microprocessor or other circuitry determine when AC power is present and control the jump starter and high frequency charger accordingly. In any case, the same set of jumper cables 316 are used to provide power from both of the jump starter 304 and the high frequency charger 306.

To provide an AC output, the internal battery 308 of jump starter 304 may be connected to an inverter for converting the DC battery current to an AC current. DC to AC inverters are well known to those of ordinary skill in the art.

The DC output 108 can be used to provide power to the built in air compressor 206, a removable light 314 or any other type of accessory.

This combination of the functionalities of a jump starter and a charger provides a motorist with the ability, not only to jump-start a vehicle with a dead battery, but also to charge the battery with the same cables used for jump-starting. No additional cables or other DC accessories are required. The motorist can further inflate a tire, and illuminate an area with the removable light. The jump starter/charger of the present invention also allows the motorist to use AC appliances anywhere.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A portable jump starter/charger apparatus, comprising:
a housing;
an AC input disposed on the housing;
a jump-starter battery enclosed within said housing and providing a first DC output;
a battery charger enclosed within said housing, receiving AC current via the AC input and providing a second DC output from the AC current;
a pair of battery cables electrically coupleable to receive a selected one of the first and second DC outputs from the jump-starter battery and the battery charger.

2. The apparatus of claim 1, further comprising a removable light mountable on the housing to be coupled to the jump starter battery.

3. The apparatus of claim 1, further comprising a DC outlet disposed in the housing to be accessible from outside of the housing, coupled to said jump starter battery, and operative to provide DC power.

4. The apparatus of claim 1, further comprising a DC input for receiving DC power and being coupled to said jump-starter battery.

5. The apparatus of claim 1, wherein said battery charger is a high frequency charger.

6. The apparatus of claim 1, further comprising an air compressor attached to the housing, the air compressor coupled to said jump starter battery to receive said first DC output.

7. The apparatus of claim 1, further comprising:
a DC to AC inverter coupled to said jump-starter battery;
an AC outlet coupled to said DC to AC inverter; and wherein said function selector switch is a three-way switch operative to switch to provide AC power at said AC outlet.

8. The apparatus of claim 1, wherein said battery charger is coupled to said jump starter battery to provide a charging current to charge said jump-starter battery.

9. The apparatus of claim 1, further comprising:
a function selector switch having a first input coupled to the first DC output of the jump-starter battery, a second input coupled to the second DC output of the charger and an output coupled to the battery cables, the function selector switch being operative to selectively couple one of the first and second inputs to the output for either jump starting a vehicle with a battery or charging the battery through the pair of battery cables.

10. The apparatus of claim 9, wherein the function selector switch is manually operated.

11. The apparatus of claim 9, wherein the function selector switch is automatically operated.

12. An apparatus, comprising:
a housing;
circuitry having an input coupled to an AC input and operative to convert the AC input into a first DC output, and an output providing said first DC output;
a storage battery disposed in said housing for producing a second DC output;
battery connectors coupled to a selected one of said output of said circuitry and said jump-starter battery for supplying the first and second DC outputs to a battery in a vehicle.

13. The apparatus of claim 12, further comprising a polarity protection circuit coupled to the battery connectors to detect a polarity between the battery connectors when connected to the target battery and to allow power to be supplied to the battery only when correct polarity is established.

14. The apparatus of claim 12, further comprising an input coupled to said storage battery for receiving a DC input to charge said storage battery.

15. The apparatus of claim 14, wherein said output of said circuitry is coupled to said input to provide said first DC output as said DC charging current.

16. The apparatus of claim 12, further comprising a removable light mountable on the housing to be coupled to the jump starter battery.

17. The apparatus of claim 12, further comprising a DC outlet disposed in the housing to be accessible from outside of the housing, coupled to said jump starter battery, and operative to provide DC power.

18. The apparatus of claim 12, further comprising a DC input for receiving DC power and being coupled to said jump-starter battery.

19. The apparatus of claim 12, further comprising a selector to manually couple said battery connectors coupled to said selected one of said output of said circuitry and said jump-starter battery.

20. The apparatus of claim 12, further comprising a selector to automatically couple said battery connectors to said selected one of said output of said circuitry and said jump-starter battery.
